(19) United States
(12) Patent Application Publication
(10) Pub. No.: US 2020/0104286 A1
(43) Pub. Date: Apr. 2, 2020

(54) MULTIDIMENSIONAL SCENE DATA GENERATING DEVICE AND METHOD BASED ON DIGITIZED WORK

(71) Applicant: BOE Technology Group Co., Ltd., Beijing (CN)

(72) Inventor: Ken WEN, Beijing (CN)

(73) Assignee: BOE Technology Group Co., Ltd.

(21) Appl. No.: 16/369,026

(22) Filed: Mar. 29, 2019

(30) Foreign Application Priority Data
Sep. 30, 2018 (CN) 201811158907.5

(51) Int. Cl. G06F 16/22; G06F 16/44; G06F 16/432

(52) U.S. Cl. CPC G06F 16/2264; G06F 16/434; G06F 16/433; G06F 16/44

(57) ABSTRACT

The present disclosure discloses a multidimensional scene data generating device and method based on a digitized work, which can acquire a digitized work; match, according to the acquired digitized work, corresponding multidimensional information data from a prestored multidimensional information database; and generate, according to the determined multidimensional information data, multidimensional scene data corresponding to a multidimensional scene to be presented.

### CROSS-REFERENCE TO RELATED APPLICATION

This application claims priority of Chinese Patent Application No. 201811158907.5, filed on Sep. 30, 2018, which is hereby incorporated by reference in its entirety.

### FIELD

The present disclosure relates to the field of multidimensional technology, in particular to a multidimensional scene data generating device and method based on a digitized work.

### BACKGROUND

In the current multidimensional experience, the scenes are preset. For example, when a user watches TV or a movie, live special effects such as vibration, blowing, smoke, bubbles and odor are introduced. These live special effects are closely combined with the movie plots to create an environment that is consistent with the contents of the movie, allowing viewers to experience new entertainment effects through multiple body senses of vision, olfaction, audition and tactility.

### SUMMARY

Some embodiments of the present disclosure provide a multidimensional scene data generating device based on a digitized work, including:

an acquiring module configured to acquire a digitized work;

a matching module configured to match, according to acquired digitized work, corresponding multidimensional information data from a prestored multidimensional information database; and

a generating module configured to generate, according to determined multidimensional information data, multidimensional scene data corresponding to a multidimensional scene to be presented.

Optionally, in some embodiments of the present disclosure, the matching module is configured to acquire a selection instruction determined by a user according to the digitized work, and match multidimensional information data corresponding to the digitized work according to the selection instruction.

Optionally, in some embodiments of the present disclosure, the generating module is configured to perform analysis processing on the determined multidimensional information data, and determine a display time of the multidimensional information data in a multidimensional scene to be presented; and generate, according to the determined multidimensional information data and the display time corresponding thereto, multidimensional scene data corresponding to the multidimensional scene to be presented.

Optionally, in some embodiments of the present disclosure, the generating module is configured to determine, according to the content of the video, a display time corresponding to the multidimensional information data in response to that the acquired digitized work is a video.

Optionally, in some embodiments of the present disclosure, the generating module is configured to determine, according to the content of the audio, a display time corresponding to the multidimensional information data in response to that the acquired digitized work is an audio.

Optionally, in some embodiments of the present disclosure, the display time includes: a start time and a cut-off time.

Optionally, in some embodiments of the present disclosure, the digitized work includes at least one of a video, an audio and a picture.

Optionally, in some embodiments of the present disclosure, the generating device further includes: a display device configured to present the multidimensional scene according to the multidimensional scene data.

Optionally, in some embodiments of the present disclosure, the generating device further includes: a correction module configured to correct, according to a correction instruction, the multidimensional information data matched by the matching module.

Optionally, in some embodiments of the present disclosure, the multidimensional information database stores at least two of visual information data, auditory information data, olfactory information data and tactile information data.

Correspondingly, some embodiments of the present disclosure further provide a multidimensional scene data generating method based on a digitized work, including:

acquiring a digitized work;

matching, according to acquired digitized work, corresponding multidimensional information data from a prestored multidimensional information database; and

generating, according to determined multidimensional information data, multidimensional scene data corresponding to a multidimensional scene to be presented.

Optionally, in some embodiments of the present disclosure, matching, according to the acquired digitized work, corresponding multidimensional information data from a prestored multidimensional information database, includes:
acquiring a selection instruction determined by a user according to the digitized work, and matching multidimensional information data corresponding to the digitized work according to the selection instruction.

Optionally, in some embodiments of the present disclosure, generating, according to the determined multidimensional information data, multidimensional scene data corresponding to a multidimensional scene to be presented, includes:

performing analysis processing on the determined multidimensional information data, and determining a display time of the multidimensional information data in a multidimensional scene to be presented; and generating, according to the determined multidimensional information data and the display time corresponding thereto, multidimensional scene data corresponding to the multidimensional scene to be presented.

Optionally, in some embodiments of the present disclosure, the method further includes:

determining, according to a content of the video, a display time corresponding to the multidimensional information data in response to that the acquired digitized work is a video. Optionally, in some embodiments of the present disclosure, the method further comprises:

determining, according to a content of the audio, a display time corresponding to the multidimensional information data in response to that the acquired digitized work is an audio.

Optionally, in some embodiments of the present disclosure, the display time comprises a start time and a cut-off time.

Optionally, in some embodiments of the present disclosure, the digitized work includes at least one of a video, an audio or a picture.

Optionally, in some embodiments of the present disclosure, the method further includes:

presenting the multidimensional scene according to the multidimensional scene data.

Optionally, in some embodiments of the present disclosure, after matching, according to the acquired digitized work, corresponding multidimensional information data from a prestored multidimensional information database, the method further includes:

correcting, according to a correction instruction, the multidimensional information data.

Optionally, in some embodiments of the present disclosure, the multidimensional information database stores at least two of visual information data, auditory information data, olfactory information data or tactile information data.

### BRIEF DESCRIPTION OF THE DRAWINGS

FIG. 1 is a structural schematic diagram of a multidimensional scene data generating device provided by some embodiments of the present disclosure.

FIG. 2 is a flowchart of a multidimensional scene data generating method provided by some embodiments of the present disclosure.

FIG. 3 is a structural schematic diagram of another multidimensional scene data generating device provided by some embodiments of the present disclosure.

### DETAILED DESCRIPTION OF THE EMBODIMENTS

In order to make the objectives, technical solutions and advantages of the present disclosure clearer, the present disclosure will be described in further detail in conjunction with the drawings. Obviously, the embodiments described herein are merely part of embodiments of the present disclosure rather than all embodiments. All other embodiments obtained by a person of ordinary skill in the art on the basis of the embodiments of the present disclosure without creative efforts fall within the scope of the present disclosure.

The shapes and sizes of the components in the drawings do not reflect true scale for the only purpose of illustrating the contents of the present disclosure.

With the development of digitized technology, digitized works are constantly emerging. Digitized works are acquired by digitizing images, sounds and other works in traditional forms.

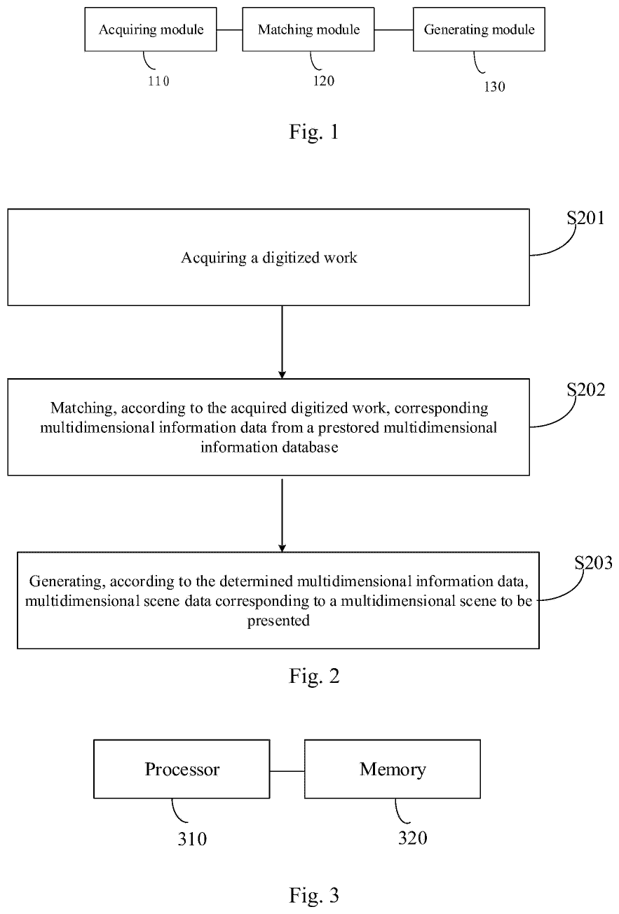

A multidimensional scene data generating device based on a digitized work provided by some embodiment of the present disclosure as shown in FIG. 1 includes:

an acquiring module 110 configured to acquire a digitized work, wherein the digitized work is prestored, and the digitized work may be stored in a local server and may also certainly be stored in a network cloud disk, which is not limited herein; the digitized work may comprise at least one of a video, an audio or a picture; the acquiring module 110 may be optionally configured to acquire a digitized work according to a user's selection; for example, when a user wants to watch a certain video, the user controls the acquiring module to acquire the video that the user wants to watch; of course, the user may not control the acquiring module, but the acquiring module acquires a certain digitized work by default; in the actual application, the digitized work can be designed and determined according to the actual application environment, which is not limited herein;

a matching module 120 configured to match, according to the acquired digitized work, corresponding multidimensional information data from a prestored multidimensional information database, in other words, the matching module 120 configured to search multidimensional information data corresponding to the acquired digitized work in a prestored multidimensional information database; and a generating module 130 configured to generate, according to the determined multidimensional information data, multidimensional scene data corresponding to a multidimensional scene to be presented.

A multidimensional scene data generating device based on a digitized work provided by the embodiments of the present disclosure can acquire a digitized work; match, according to the acquired digitized work, corresponding multidimensional information data from a prestored multidimensional information database; and generate, according to the determined multidimensional information data, multidimensional scene data corresponding to a multidimensional scene to be presented, thereby implementing a multidimensional scene based on the digitized work according to the generated multidimensional scene data.

It should be noted that in the present disclosure, a multidimensional scene generally refers to a scene that a human feels at least through vision, audition, tactility and olfaction. The multidimensional information data may include: vision-related digitized visual information data, audition-related digitized auditory information data, tactility-related digitized tactile information data, and olfaction-related digitized olfactory information data. The visual information data may be various videos, various light displays, and the like. The auditory information data may be various sounds such as music, sounds of various animals, and the like. The olfactory information data may be various odors. The tactile information data may be tactile stimuli of a human body such as water droplets, wind, cold air, hot air, and the like. In a specific implementation, the multidimensional information database may store at least two of visual information data, auditory information data, olfactory information data or tactile information data. In addition, the multidimensional information database contains a large amount of prestored information data, which may be stored in a local server and may also certainly be stored in a network cloud disk, which is not limited herein. Further, each of the visual information data, auditory information data, olfactory information data and tactile information data includes a subject name, a content, data for control, and the like, respectively. Taking the visual information data as an example, if one of the visual information data is a video, and the corresponding visual information data may comprise a subject name of the video, a display content of the video, data for controlling the video, and the like.

In a specific implementation, the generating device may further include: a display device configured to present the multidimensional scene according to the multidimensional scene data. In this way, the multidimensional scene data generated by the generating module can be presented by the display device to generate a multidimensional scene, thereby giving a person an immersive feeling. Optionally, in some embodiments of the present disclosure, the display device corresponding to various materials refers to any device for generating stimuli that can be sensed by organisms such as human senses. For example, the display device corresponding to the visual information data in the multidimensional scene data is a visual display device, the display device corresponding to the auditory information data in the multidimensional scene data is an auditory display device, the display device corresponding to the olfactory information data in the multidimensional scene data is an olfactory display device, and the display device corresponding to the tactile information data in the multidimensional scene data is a tactile display device. By controlling these display devices, a user can experience a multidimensional scene. In a specific implementation, the above display devices can be automatically controlled by a computing device or a controller device, which therefore further has any computing function integrated into the display devices. Optionally, the display device corresponding to the visual information data is at least one of a display screen, a projector or a light. Optionally, the display device corresponding to the auditory information data is a speaker.

In a specific implementation, the matching module may be configured to acquire a selection instruction determined by a user according to the digitized work, and match, according to the selection instruction, multidimensional information data corresponding to the digitized work. Optionally, for example, if the digitized work is an art painting which depicts Moonlight over the Lotus Pond, a user can issue a selection instruction to the matching module according to the Moonlight over the Lotus Pond in the art painting, so that the matching module can select, from the multidimensional information database, the visual information data of the Moonlight over the Lotus Pond, the auditory information data of water sounds when rowing and frog croaking, the olfactory information data of lotus scent, and the tactile information data of a breeze blowing feeling. Then, the generating module generates, according to the determined multidimensional information data, multidimensional scene data corresponding to the Moonlight over the Lotus Pond in the art painting to be presented. Then, according to the determined multidimensional scene data, the multidimensional scene of the Moonlight over the Lotus Pond is presented by corresponding display devices, so as to give a person the feeling in the Moonlight over the Lotus Pond. In this way, a user may select the multidimensional scene to be presented according to his/her needs.

Optionally, in the generating system of a multidimensional experience scene provided by embodiments of the present disclosure, the generating module is further configured to save the generated multidimensional scene data corresponding to the multidimensional scene to be presented. In this way, when a user is satisfied with the generated multidimensional scene data corresponding to the multidimensional scene to be presented, he/she may save the multidimensional scene data.

Optionally, in some embodiments of the present disclosure, the generating device may further include: a correction module configured to correct, according to a correction instruction, the multidimensional information data matched by the matching module. Further, the correction instruction may be input by a user, thereby controlling the correction module to perform operations such as deleting and re-editing the multidimensional information data matched by the matching module. For example, when a user is not satisfied with the generated multidimensional scene data corresponding to the multidimensional scene to be presented, he/she may input a correction instruction, re-select multidimensional information data, and again control the generating module to generate multidimensional scene data, thereby further selecting multidimensional information data according to the user's needs.

In a specific implementation, the generating module may be configured to perform analysis processing on the determined multidimensional information data, and determine a display time of the multidimensional information data in a multidimensional scene to be presented; and generate, according to the determined multidimensional information data and the display time corresponding thereto, multidimensional scene data corresponding to the multidimensional scene to be presented. Thus, the multidimensional scene data may include: multidimensional information data and a display time corresponding to the multidimensional information data, wherein the display time may include: a start time and a cut-off time. For example, if the auditory information data includes two different bird tweet, analysis processing is performed on the two different bird tweet in the auditory information data to determine a start time and a cut-off time of the two bird tweet. Then, multidimensional scene data corresponding to the scene to be presented is generated according to the two bird tweet and the start time and the cut-off time corresponding thereto.

In a specific implementation, the acquired digitized work may be a video. In an embodiment of the present disclosure, the generating module may be configured to determine, according to the content of the video, a display time corresponding to the multidimensional information data. In this way, when the corresponding multidimensional scene is presented according to the generated multidimensional scene data, the multidimensional scene data is presented according to the multidimensional information data and the determined display time. For example, if the digitized work is a video for a flower sea and a forest, a user may issue a selection instruction to the matching module according to time, place, character and event, so that the matching module can select, from the multidimensional information database, the auditory information data of insect acoustic and bird tweet, and the olfactory information data of floral and earthy taste. Then, the generating module performs analysis processing on the selected information data according to the content of the flower sea and the forest in the video as the digitized work to determine a start time and a cut-off time of the selected information data in the multidimensional scene. Then, the multidimensional scene data is generated according to the selected information data and the start time and the cut-off time of the information data in the multidimensional scene. When the multidimensional scene is displayed, the multidimensional scene is displayed by display devices. Optionally, when the picture of the flower sea appears in the video, the insect acoustic and the picture are presented; when the forest appears in the video, the bird tweet and the earthy taste are presented.

In a specific implementation, the acquired digitized work may be an audio. In some embodiments of the present disclosure, the generating module may be configured to determine a display time corresponding to the multidimensional information data according to the content of the audio. In this way, when the corresponding multidimensional scene is presented according to the generated multidimensional scene data, the multidimensional scene data is presented according to the multidimensional information data and the determined display time. For example, if the digitized work is an audio for sounds in the Moonlight over the Lotus Pond (such as water sounds when rowing and frog croaking), a user may issue a selection instruction to the matching module according to time, place, character and event, so that the matching module can select, from the multidimensional information database, the visual information data of the Moonlight over the Lotus Pond and rowing, the auditory information data of water sounds when rowing and frog croaking, the olfactory information data of lotus scent, and the tactile information data of a breeze blowing feeling. Then, the generating module performs analysis processing on the selected information data according to the content of the audio as the digitized work to determine a start time and a cut-off time of the selected information data in the multidimensional scene. For example, when there are water sounds of rowing, the visual information displayed at this time is a picture of rowing, and the tactile information displayed at the same time is a breeze blowing feeling; when there are frog croaking, the visual information at this time is the Moonlight over the Lotus Pond. Then, the multidimensional scene data is generated according to the selected information data and the start time and the cut-off time of the information data in the multidimensional scene. When the multidimensional scene is displayed, the multidimensional scene is displayed by display devices.

Further, the generating module is further configured to generate various control signals according to each determined display time to control a display device corresponding to the multidimensional information data to display the corresponding information data. Optionally, the generating module includes any device or processor that can perform data analysis and processing, and is suitable for controlling a display device by transmitting a control signal to the display device. For example, the generating module may be a controller or a personal computer or the like.

In a specific implementation, the generating module may be connected to display devices through a line or a network. The network includes a network through which control signals and data can interact with each other by several communicating parties. For example, the network can be a local area network (LAN), a Bluetooth-based personal area network (PAN), or a wireless LAN (WLAN). The network simplifies the connection between the generating module and the display devices.

In a specific implementation, the selection module may be implemented by a server suitable for receiving input data, loading from a database multidimensional information data corresponding to the input data, and transmitting the multidimensional information data to the generating module.

In a specific implementation, the multidimensional scene data generating device based on a digitized work provided by some embodiments of the present disclosure is suitable for creating a multidimensional scene according to a user's own needs. In a specific implementation, it can be applied to theaters, art exhibitions, and the like. Taking an electronic painting exhibition as an example, there are multiple art paintings in a general painting screen, and each art painting has a corresponding atmosphere (multidimensional scene). When the art paintings are displayed, a multidimensional scene that matches the paintings is displayed by using display devices in the generating device. For example, a painting of the Moonlight over the Lotus Pond may display a multidimensional scene as follows: watching a video that a boat shuttles through the lotus pond in the evening, the user can smell the lotus, hear the frog croaking, and feel the breeze blowing. Of course, during the display process, the user can also correct or create the multidimensional scene corresponding to the art painting, such as re-selecting some materials.

On the basis of the same inventive concept, some embodiments of the present disclosure further provide a multidimensional scene data generating method based on a digitized work, as shown in FIG. 2, including:

S201, acquiring a digitized work;

S202, matching, according to the acquired digitized work, corresponding multidimensional information data from a prestored multidimensional information database, in other words, searching multidimensional information data corresponding to the acquired digitized work in a prestored multidimensional information database; and

S203, generating, according to the determined multidimensional information data, multidimensional scene data corresponding to a multidimensional scene to be presented.

In a specific implementation, step S202 may include: acquiring a selection instruction determined by a user according to the digitized work, and matching multidimensional information data corresponding to the digitized work according to the selection instruction.

In a specific implementation, step S203 may include: performing analysis processing on the determined multidimensional information data, and determining a display time of the multidimensional information data in a multidimensional scene to be presented; and generating, according to the determined multidimensional information data and the display time corresponding thereto, multidimensional scene data corresponding to the multidimensional scene to be presented.

In a specific implementation, when the acquired digitized work is a video, in some embodiments of the present disclosure, the generating module is configured to determine, according to the content of the video, a display time corresponding to the multidimensional information data.

In a specific implementation, when the acquired digitized work is an audio, in some embodiments of the present disclosure, the generating module is configured to determine, according to the content of the audio, a display time corresponding to the multidimensional information data.

In a specific implementation, after generating the multidimensional scene data corresponding to the multidimensional scene to be presented, the method further includes: saving the generated multidimensional scene data corresponding to the multidimensional scene to be presented.

On the basis of the same inventive concept, some embodiments of the present disclosure further provide a multidimensional scene data generating device based on a digitized work, as shown in FIG. 3, including:

the processor 310 is configured to read the computer readable program to perform the multidimensional scene data generating method based on a digitized work according to any one of aforementioned embodiments.

The multidimensional scene data generating device and method based on a digitized work provided by the embodiments of the present disclosure can acquire a digitized work; match, according to the acquired digitized work, corresponding multidimensional information data from a prestored multidimensional information database; and generate, according to the determined multidimensional information data, multidimensional scene data corresponding to a multidimensional scene to be presented, thereby implementing a multidimensional scene based on the digitized work according to the generated multidimensional scene data.

Obviously, a person skilled in the art can make various modifications and variations to the present disclosure without departing from the spirit and scope of the present disclosure. Thus, if these modifications and variations of the present disclosure fall within the scope of the claims of the present disclosure and the equivalent art, the present disclosure is also intended to include these modifications and variations.

1. A multidimensional scene data generating device based on a digitized work, comprising:
an acquiring module configured to acquire a digitized work;
a matching module configured to match, according to acquired digitized work, corresponding multidimensional information data from a prestored multidimensional information database; and
a generating module configured to generate, according to determined multidimensional information data, multidimensional scene data corresponding to a multidimensional scene to be presented.

2. The multidimensional scene data generating device based on a digitized work of claim 1, wherein the matching module is configured to acquire a selection instruction determined by a user according to the digitized work, and match multidimensional information data corresponding to the digitized work according to the selection instruction.

3. The multidimensional scene data generating device based on a digitized work of claim 1, wherein the generating module is configured to perform analysis processing on the determined multidimensional information data, and determine a display time of the multidimensional information data in a multidimensional scene to be presented; and generate, according to the determined multidimensional information data and the display time corresponding thereto, multidimensional scene data corresponding to the multidimensional scene to be presented.

4. The multidimensional scene data generating device based on a digitized work of claim 3, wherein the generating module is configured to determine, according to a content of the video, a display time corresponding to the multidimensional information data in response to that the acquired digitized work is a video.

5. The multidimensional scene data generating device based on a digitized work of claim 3, wherein the generating module is configured to determine, according to a content of the audio, a display time corresponding to the multidimensional information data in response to that the acquired digitized work is an audio.

6. The multidimensional scene data generating device based on a digitized work of claim 3, wherein the display time comprises a start time and a cut-off time.

7. The multidimensional scene data generating device based on a digitized work of claim 1, wherein the digitized work comprises at least one of a video, an audio or a picture.

8. The multidimensional scene data generating device based on a digitized work of claim 1, further comprises a display device configured to present the multidimensional scene according to the multidimensional scene data.

9. The multidimensional scene data generating device based on a digitized work of claim 1, further comprises a correction module configured to correct, according to a correction instruction, the multidimensional information data matched by the matching module.

10. The multidimensional scene data generating device based on a digitized work of claim 1, wherein the multidimensional information database stores at least two of visual information data, auditory information data, olfactory information data or tactile information data.

11. A multidimensional scene data generating method based on a digitized work, comprising:
acquiring a digitized work;
matching, according to the acquired digitized work, corresponding multidimensional information data from a prestored multidimensional information database; and
generating, according to the determined multidimensional information data, multidimensional scene data corresponding to a multidimensional scene to be presented.

12. The multidimensional scene data generating method based on a digitized work of claim 11, wherein matching, according to the acquired digitized work, corresponding multidimensional information data from a prestored multidimensional information database, comprises:
acquiring a selection instruction determined by a user according to the digitized work, and matching multidimensional information data corresponding to the digitized work according to the selection instruction.

13. The multidimensional scene data generating method based on a digitized work of claim 11, wherein generating, according to the determined multidimensional information data, multidimensional scene data corresponding to a multidimensional scene to be presented, comprises:
performing analysis processing on the determined multidimensional information data, and determining a display time of the multidimensional information data in a multidimensional scene to be presented; and generating, according to the determined multidimensional information data and the display time corresponding thereto, multidimensional scene data corresponding to the multidimensional scene to be presented.

14. The multidimensional scene data generating method based on a digitized work of claim 13, further comprises:
determining, according to a content of the video, a display time corresponding to the multidimensional information data in response to that the acquired digitized work is a video.

15. The multidimensional scene data generating method based on a digitized work of claim 13, further comprises:
determining, according to a content of the audio, a display time corresponding to the multidimensional information data in response to that the acquired digitized work is an audio.

16. The multidimensional scene data generating method based on a digitized work of claim 13, wherein the display time comprises a start time and a cut-off time.

17. The multidimensional scene data generating method based on a digitized work of claim 11, wherein the digitized work comprises at least one of a video, an audio or a picture.

18. The multidimensional scene data generating method based on a digitized work of claim 11, further comprises:
presenting the multidimensional scene according to the multidimensional scene data.

19. The multidimensional scene data generating method based on a digitized work of claim 11, wherein after matching, according to the acquired digitized work, corresponding multidimensional information data from a prestored multidimensional information database, the method further comprises:
correcting, according to a correction instruction, the multidimensional information data.

20. The multidimensional scene data generating method based on a digitized work of claim 11, wherein the multidimensional information database stores at least two of visual information data, auditory information data, olfactory information data or tactile information data.
